(19) United States
(12) Patent Application Publication
(10) Pub. No.: US 2011/0011779 A1
(43) Pub. Date: Jan. 20, 2011

(54) SCOOP DEVICE FOR SEPARATING MANURE FROM BEDDING

(76) Inventor: Daniel Edward Riccardi, Siler City, NC (US)

Correspondence Address: PASSE' INTELLECTUAL PROPERTY, LLC, 1717 BRASSFIELD RD., RALEIGH, NC, 27614, US

(21) Appl. No.: 12/503,542

(22) Filed: Jul. 15, 2009

(51) Int. Cl. B07B 1/02; B07C 7/04

(52) U.S. Cl. 209/614; 209/419

(57) ABSTRACT

The present invention is directed to a device useful for separating manure from bedding material when mucking an animal's stall. The device has a handle and a scoop. The scoop has a blade and multiple holes which allow bedding material, such as wood chips, to fall through but which is small enough to retain manure clumps in the scoop. A method of use of the device is also taught.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a device for separation of recyclable bedding material from manure on the floor of an animal's stall such as a horse's stall.

2. Description of Related Art

The problem of removing manure from the stables, stalls, and bedding areas of an animal, a task commonly known as “mucking,” in an efficient manner goes back to ancient times. Hercules, according to myth, was given the job of cleaning the stables of the gods. He accomplished his mission by diverting a river to flush away the manure. Through the ages, mere mortals lacking the power of Hercules have resorted to rakes and shovels to carry out the unpleasant but essential task of mucking.

Typically, the floor of an animal bedding area, such as a horse's stall, is covered with a layer of inexpensive, absorptive material such as wood shavings, saw dust, sand and the like. While straw is occasionally used as a bedding material, it has a disposal problem and smaller finer materials are the usual bedding material of choice. The problem associated with mucking is to efficiently remove the manure and leave behind the bedding material. The patent literature teaches numerous devices to facilitate mucking. For example, U.S. Pat. No. 226,351 that issued in 1880 claims a shovel like device constructed of heavy wire. U.S. Pat. No. 5,417,044 describes a rake and basket combination. U.S. design Pat. Des 406,413 presents a specialized mucking rake, and U.S. Pat. No. 7,044,520 teaches a motor powered basket type scoop. Even with the plethora of mucking devices in the art, there is still a need to more rapidly and more efficiently separate manure from bedding.

### BRIEF SUMMARY OF THE INVENTION

The first aspect of the present invention is a hand operated device for separating manure from bedding material especially for smaller bedding material such as shavings, wood chips and sand. The device has a handle and a scoop. The scoop with a longitudinal axis, a transverse axis, and an edge around its perimeter has:
a) a proximal partially concave top section and corresponding partially convex bottom section with a handle socket merging into the partially concave top section wherein the handle is affixed to the scoop along the longitudinal axis;
b) a substantially flat upper section and corresponding lower section distal to the socket and terminating at a substantially straight, firm section of the edge having a plurality of teeth;
c) optionally one or more ribs extending from the vicinity of the socket, from the partially concave upper section, across the flat upper section to the vicinity of the edge forming two or more channels; and
d) a plurality of holes in areas not occupied by the ribs or in close proximity to the edge.

The second aspect is a method of separating manure from bedding material by:
a) moving the device of the first aspect by the handle to force the scoop under a pile of manure mixed with bedding material to fill the scoop with the manure and the concomitant bedding material clinging to the manure;
b) raising the device above the bedding material with the flat section of the scoop substantially parallel to the bedding material; and
c) vibrating the device to cause particles of bedding material to pass through the holes leaving the manure in the scoop.

The device of the present invention is easy to operate and easy to clean. Its scoop featuring a partial flat bottom and blade may rapidly be pushed around an animal's stall to collect manure.

### BRIEF DESCRIPTION OF THE DRAWINGS

FIG. 1 is a top view of the device showing the handle and scoop.

FIG. 2a shows the top view of the scoop.

FIG. 2b shows the bottom of the scoop.

FIG. 3 is a perspective view of the scoop and handle socket.

### DETAILED DESCRIPTION OF THE INVENTION

While this invention is susceptible to embodiment in many different forms, herein will be described certain specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one, or more than one. The term “plurality”, as used herein, is defined as two or more. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”,“certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

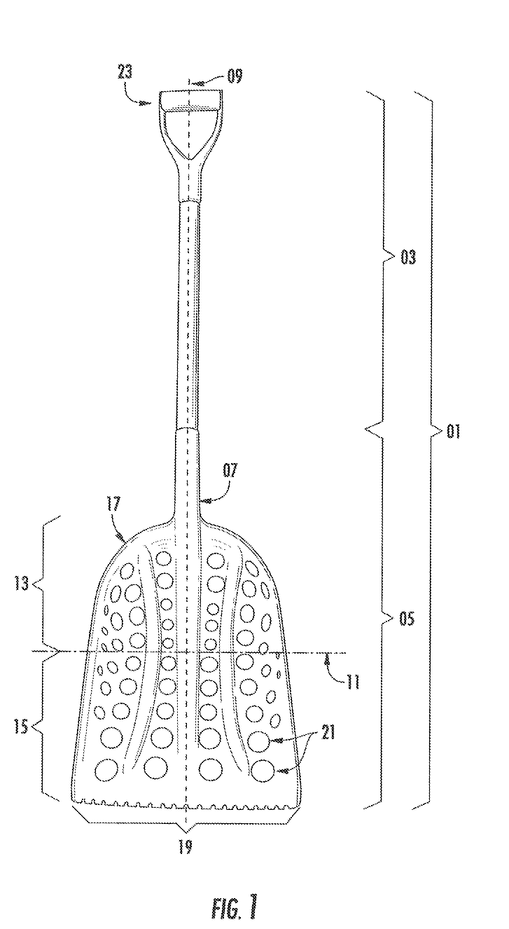

FIG. 1 illustrates the device 01 as viewed from its top showing handle 03 and scoop 05 wherein the handle is attached to the scoop by means of handle socket 07. Device 01 has a longitudinal axis 09 (depicted by a dashed line extending along handle 03 trough the middle of scoop 05), and a traverse axis 11 (depicted by a dash-dot-dash line) that separates the scoop's curved section 13 (proximal to handle 03) from the scoop's substantially flat section 15 distal to the handle. Scoop 05 has an edge 17 that extends around the scoop's perimeter and separates the top of the scoop from its bottom section. The part of edge 17 that is distal to the handle is substantially straight and is substantially parallel to traverse axis 11 to forms blade 19. Scoop 05 has a plurality of holes (collectively, “holes 21,” two of which are labeled in FIG. 1) extending from handle socket 07 to blade 19.

The handle is a convenient length typical of mucking devices of the art. Typically, it is about 0.5 m to about 1.5 m. Optionally, the handle may be fitted with a grip such as a “D” shaped grip 23 as shown in the embodiment illustrated in FIG. 1.

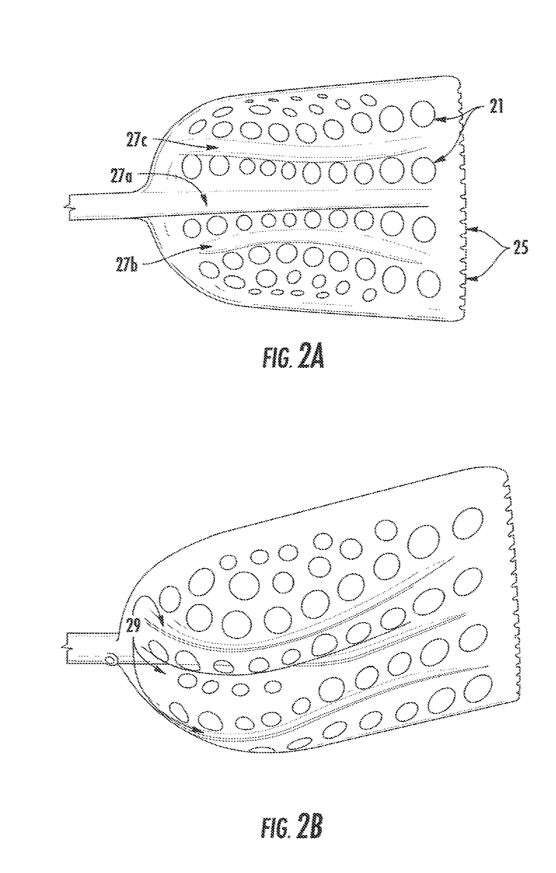

FIG. 2a provides a detailed illustration of the top of scoop 05 while FIG. 2b provides a corresponding illustration of its bottom. These two figures are conveniently viewed together. Blade 19 may be sharp, semi sharp, or blunt, also, according to the embodiment illustrated in FIGS. 1-3, it may have a plurality of teeth 25. Optionally, scoop 05 may have one or more ribs 27 as shown in the figures (three such ribs are depicted in the specific embodiment shown in the figures). Conveniently, Scoop 05 has a major rib 27a along its longitudinal axis, starting as an extension of handle socket 07 and merging into flat section 15 in the vicinity of blade 19, and two minor ribs 27b and 27c symmetrically positioned with respect to major rib 27a as depicted in the specific embodiment shown in the figures. As viewed from the bottom of scoop 05 (FIG. 2b) ribs 27 may have a corresponding recessed areas 29. Alternatively, the bottom of scoop 05 may be smooth or bear a separate set of ribs corresponding to ribs 27.

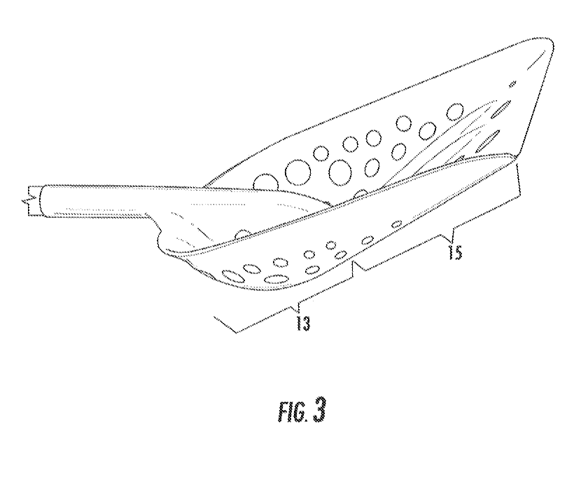

FIG. 3, a perspective view of scoop 05, is present to more completely illustrate the spatial relationship of the features of the specific embodiment illustrated in the other figures. Further, FIG. 3 shows how the curved section 13 morphs into flat section 15, which in turn, terminates as blade 19.

Ribs 25 serve to maintain the structural integrity of scoop 05 as well as channeling material across holes 21. Conveniently, ribs 27 are formed as part of the molding or stamping process by which scoop 05 is manufactured.

Holes 21 may be of the same or different sizes, and they may be various geometric shapes other than thin, elongated slits, but, conveniently, holes 21 are rounded shapes such as circles, ovals, or ellipses. By having a plurality of different sized holes, bedding of various sizes or that clump together can both be separated from manure with the present invention mucking tool. In general, one choosing the holes will size them to allow the smaller bedding material to pass through the mucking tool while allowing the manure to remain in the tool. One skilled in the art in view of this disclosure would readily understand how to match a series of various sized holes to match the particular bedding. In one embodiment the holes are matched to the particular bedding. Holes for sand, holes for wood shavings etcetera could be on a tool alone or in combination to provide a tool for use with various sized bedding material. The present device, therefore, is not as efficient with larger bedding material, such as straw, since large straw will not easily pass through holes designed for smaller bedding. However, since the majority of horse owners do not use straw, this is of little concern for most users of the present invention mucking tool. The manure separating devices of the art have grids of parallel rods or course screens that tend to get clogged. The present device with its larger holes avoids the clogging problem. The sizes of the holes are small enough to restrict passage of clumps of manure, but freely allow the passage of the bedding material. For example, if holes 21 are circular, their diameters might range from about 20 mm to about 60 mm. Conveniently, holes 21 are largest in the vicinity of blade 19 diminishing toward handle socket 19.

In the embodiment shown in the figures, holes 21 are symmetrically distributed with respect to the longitudinal axis of the scoop. However, for some applications it may be desirable to have an asymmetric distribution of holes 21. For example, the holes on one side (with respect to the longitudinal axis) of the scoop may be larger than those on the other side to allow large size manure clumps to be rapidly removed while the sides having the small holes would be used for small clumps. Therefore, the operator of the present device could adjust the device to different size clumps typically encountered in an animal bedding area.

Device 01 may be fabricated of material used in the art for shovels, rakes, and similar hand tools used to clean animal stalls. For example, handle 03 may be made of wood, metal, polymeric materials, or a combination thereof. Likewise, scoop 05 may be made of metal, e.g., aluminum, optionally covered with an anti-stick polymer such as tetrafluropolyethylene, or it may be made of a polymeric material such as a polyamide, polyester, polyvinyl, and the like. Further, device 01 may be fabricated by processes well know in the art for manufacturing such tools. Conveniently, scoop 05 may be stamped using high pressure and optionally heat from a sheet of metal or polymeric material.

Device 01 is employed in a similar manner as mucking devices of the art. That is, scoop 05 is pushed under a clump of manure sitting on bedding material in the floor of an animal's bedding area, e.g. a horse's stall, and then lifted by handle 03 above the level of the floor with the flat section of scoop 05 substantially parallel to the bedding material. The device is then vibrated vigorously by hand to cause the loose particles of bedding material, such as wood shavings, to fall through holes 21 to the stall floor. The manure remaining in scoop 05 is discarded and the process is repeated.

What is claimed is:

1. A hand operated device for separating manure from bedding material comprising:
a) a handle, and
b) a scoop with a longitudinal axis, a transverse axis, and an edge around its perimeter having
i. a proximal partially concave top section and corresponding partially convex bottom section with a handle socket merging into the partially concave upper section wherein the handle is affixed to the scoop along the longitudinal axis;
ii. a substantially flat upper section and corresponding lower section distal to the socket and terminating at a substantially straight section of the edge that forms a blade;
iii. optionally, one or more ribs extending from the vicinity of the socket, from the partially concave upper section, across the flat upper section to the vicinity of the edge forming two or more channels; and
iv. a plurality of holes in areas not occupied by the optional ribs or in close proximity to the edge or blade.

2. The device of claim 1, which is composed of wood, metal, a polymeric material, or a combination thereof.

3. The device of claim 2 wherein the handle is composed of wood and the scoop is composed of a polymeric material.

4. The device of claim 2 wherein the scoop has a non-stick surface.

5. The device of claim 1 wherein the holes are substantially rounded.

6. The device of claim 5 wherein the holes are substantially circular.

7. The device of claim 1 wherein the holes are of a plurality of sizes.

8. The device of claim 1 wherein the handle socket extends into the upper concave and flat sections of the scoop, along the longitudinal axis, to form a major rib that merges with the flat section in the proximity of the distal, substantially straight edge.

9. The device of claim 8 wherein the scoop has two additional ribs symmetrically situated on each side of the major rib.

10. The device of claim 1 wherein the handle terminates in a “D” shaped grip distal to the end of the handle affixed to the handle socket.

11. The device of claim 1 wherein the blade bears a plurality of teeth.

12. A method of separating manure from bedding material comprising:
a) moving the device of claim 1 by the handle to force the scoop under a pile of manure mixed with bedding material of an animal's stall to fill the scoop with the manure and the concomitant bedding material clinging to the manure,
b) raising the device above the bedding material with the flat section of the scoop above the level of the bedding material, and
c) vibrating the device to cause particles of bedding material to pass through the holes leaving the manure in the scoop.

13. The method of claim 12 wherein step a) the device is raised so that the flat section is substantially parallel to the level of the bedding material.

14. The method of claim 12 wherein the bedding material is selected from the group consisting of wood shavings, wood chips and sand.
